(19) United States
(12) Patent Application Publication
(10) Pub. No.: US 2013/0313991 A1
(43) Pub. Date: Nov. 28, 2013

(54) FLICKER-FREE LINEAR LED DRIVER CIRCUIT WITH HIGH POWER FACTOR

(71) Applicant: LUXUL TECHNOLOGY INCORPORATION, New Taipei City (TW)

(72) Inventors: Cheng-Hung PAN, New Taipei City (TW); Perng-Fei YUH, New Taipei City (TW)

(73) Assignee: LUXUL TECHNOLOGY INCORPORATION, New Taipei City (TW)

(21) Appl. No.: 13/890,788

(22) Filed: May 9, 2013

(30) Foreign Application Priority Data
May 23, 2012 (TW) 101118305

(51) Int. Cl. H05B 33/08

(52) U.S. Cl. CPC H05B 33/0809
USPC 315/201

(57) ABSTRACT

The flicker-free linear LED driver circuit with high power factor has a rectifier unit, an LED unit, a constant current unit, a storage capacitor and a voltage controlled transistor; the rectifier unit is connected to an AC power and converts the AC power into a pulsating DC power; the LED unit is connected to the rectifier unit and has multiple LED sources; the constant current unit is connected in series with the LED unit to form a first power circuit; wherein current flowing in the LED unit is fixed to a constant value by the constant current unit; the storage capacitor is connected to the rectifier unit; the voltage controlled transistor is connected in series with the storage capacitor to form a second power circuit; wherein the voltage controlled transistor limits current flowing in the storage capacitor under a maximum current limit value.

### CROSS-REFERENCE TO RELATED APPLICATIONS

This application claims the benefit of Taiwan patent application No. 101118305, filed on May 23, 2012, the disclosure of which is incorporated herein in its entirety by reference.

### BACKGROUND OF THE INVENTION

1. Field of the Invention

The present invention relates to an LED driver circuit and more particularly to a flicker-free linear LED driver circuit with high power factor.

2. Description of Related Art

LEDs are common lighting appliances nowadays. Compared to conventional incandescent bulbs, LEDs have advantages of higher luminous efficiency and lower power consumption. However, LEDs can only be conducted in a one-way circuit such that LEDs cannot be connected to a conventional AC outlet. Therefore, an LED driver circuit is invented. With reference to FIG. 7, the conventional LED driver circuit has:
a rectifier unit 20 connected to an AC power and converting the AC power into a pulsating DC power;
an LED unit 21 having multiple LED sources and connected in series with the rectifier unit 20;
a constant current unit 22 connected in series with the LED unit 21 to form a first power circuit; wherein current flowing in the LED unit 21 is fixed to a constant value by the constant current unit 22; and
a storage capacitor 23 connected to the rectifier unit 20 and forming a second power circuit; wherein the second power circuit is connected in parallel with the first power circuit.

Based on the above-mentioned structure, the conventional LED driver circuit converts the AC power into the pulsating DC power by the rectifier unit 20, and then fixes the current I_{LED} flowing in the LED unit 21 at a constant value by the constant current unit 22 to stabilize a luminance of the LED unit 21. Furthermore, in order to prevent the LED unit 21 from having a stroboscopic effect due to instability of a voltage V_{dc} of the pulsating DC power, the storage capacitor 23 with a charging-and-discharging characteristic is utilized to eliminate the stroboscopic effect.

With reference to FIGS. 8A and 8B, when the voltage V_{dc} of the pulsating DC power outputted by the rectifier unit 20 is higher than a voltage V_{C} of the storage capacitor 23, current I_{dc} of the pulsating DC power supplies power to the LED unit 21 and charges the storage capacitor 23. When the voltage V_{dc} of the pulsating DC power outputted by the rectifier unit 20 is lower than the voltage V_{C} of the storage capacitor 23 and the voltage V_{C} of the storage capacitor 23 is higher than a junction voltage V_{LED}, a reverse discharge current I_{C} of the storage capacitor 23 supplies power to the LED unit 21, that is, the storage capacitor 23 produces a stable current to the LED unit 21 and eliminates the stroboscopic effect effectively.

In conclusion, when the voltage V_{dc} of the pulsating DC power is higher than the voltage V_{C} of the storage capacitor 23, the pulsating DC power charges the storage capacitor 23 and the electric charges thus charged are sufficient for producing the stable discharge current I_{C} to the LED unit 21 before next charging. Hence, the current I_{dc} of the pulsating DC power rises instantaneously upon a moment of charging the storage capacitor 23. Similarly, when the voltage V_{dc} of the pulsating DC power is lower than the voltage V_{C} of the storage capacitor 23, the pulsating DC power stops supplying power to the LED unit 21 and stops charging the storage capacitor 23. Hence, the current I_{dc} of the pulsating DC power instantaneously reduces to 0 A upon discharging of the storage capacitor 23. Therefore, the current I_{dc} of the pulsating DC power forms a glitch waveform having high amplitude, and causes severe distortion of the waveform.

Furthermore, by Fourier analysis, a displacement angle ψ between a fundamental wave of the current I_{dc} and a fundamental wave of the voltage V_{dc} of the pulsating DC power is obtained, and a THD (total harmonic distortion) of the current I_{dc} of the pulsating DC power under the frequency domain can also be obtained by the following formula:

$$PF = \frac{cos φ}{\sqrt{1 + {THD}^{2}}}$$

A PF (power factor) of the pulsating DC power decreases when the waveform severely deforms due to the harmonic distortion of the current I_{dc} of the pulsating DC power. Therefore, a better solution must be provided to solve the above-mentioned problem.

### SUMMARY OF THE INVENTION

The main objective of the invention is to provide a flicker-free linear LED driver circuit with high power factor.

The LED driver circuit comprises:
a rectifier unit connected to an AC power and converting the AC power into a pulsating DC power;
an LED unit connected to the rectifier unit and having multiple LED sources;
a constant current unit connected in series with the LED unit to form a first power circuit with the LED unit and the rectifier unit; wherein current flowing in the LED unit is fixed to a constant value by the constant current unit;
a storage capacitor connected to the rectifier unit; and
a voltage controlled transistor connected in series with the storage capacitor to form a second power circuit with the storage capacitor and the rectifier unit; wherein the voltage controlled transistor limits current flowing in the storage capacitor under a maximum current limit value.

In conclusion, the LED driver circuit limits the current flowing in the storage capacitor under a maximum current limit value such that the current flowing in the storage capacitor does not rise instantaneously and a glitch waveform having high amplitude is not formed. Accordingly the waveform of the voltage V_{dc} is closer to the waveform of the current I_{dc} of the pulsating DC power compared to the conventional LED driver circuit, that is, the harmonic distortion of the current I_{dc} of the pulsating DC power is decreased and the objective of raising the power factor is achieved.

### BRIEF DESCRIPTION OF THE DRAWINGS

FIG. 1 is a circuit diagram of a first embodiment of an LED driver circuit in accordance with the present invention;

FIG. 2A is a waveform chart of voltage of nodes of each unit of the LED driver circuit in FIG. 1;

FIG. 2B is a waveform chart of current flowing in each unit of the LED driver circuit in FIG. 1;

FIG. 3 shows characteristic curves of a conventional LED driver circuit, the LED driver circuit in FIG. 1, and the LED driver circuit in FIG. 1 without a storage capacitor;

FIG. 4 shows another set of characteristic curves of the conventional LED driver circuit, the LED driver circuit in FIG. 1 and the LED driver circuit in FIG. 1 without a storage capacitor;

FIG. 5 is a circuit diagram of a second embodiment of an LED driver circuit in accordance with the present invention;

FIG. 6 is a circuit diagram of a third embodiment of an LED driver circuit in accordance with the present invention;

FIG. 7 is a circuit diagram of the conventional LED driver circuit;

FIG. 8A is a waveform chart of voltage of node of each unit of the conventional LED driver circuit in FIG. 7; and

FIG. 8B is a waveform chart of current flowing in each unit of the conventional LED driver circuit in FIG. 7.

### DETAILED DESCRIPTION OF THE PREFERRED EMBODIMENTS

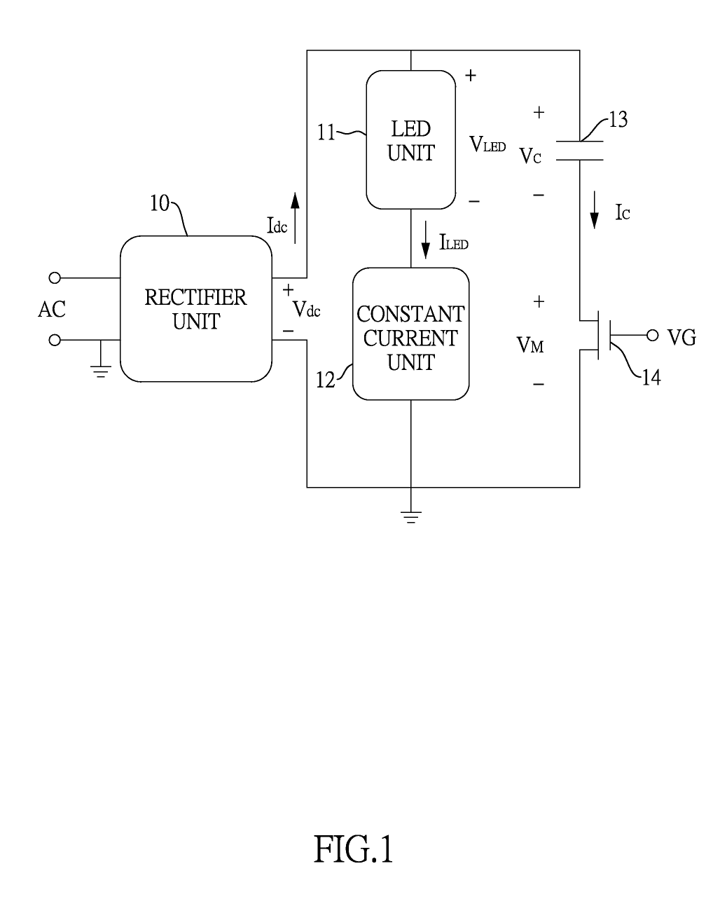

With reference to FIG. 1, a preferred embodiment of an LED driver circuit in accordance with the present invention comprises:
a rectifier unit 10 connected to an AC power and converting the AC power into a pulsating DC power; in a preferred embodiment, the rectifier unit 10 is a full-wave rectifier;
an LED unit 11 connected to the rectifier unit 10 and having multiple LED sources; in a preferred embodiment, each LED source is connected in series, parallel or series-parallel with another LED source;
a constant current unit 12 connected in series with the LED unit 11 to form a first power circuit with the LED unit 11 and the rectifier unit 10; wherein current flowing in the LED unit 11 is fixed to a constant value by the constant current unit 12; in a preferred embodiment, the constant current unit 12 is a constant current feedback circuit controlled by a transistor unit, a current detection unit and a regulator circuit;
a storage capacitor 13 connected to the rectifier unit 10; in a preferred embodiment the storage capacitor 13 is a ceramic capacitor or an electrolytic capacitor; and
a voltage controlled transistor 14 connected in series with the storage capacitor 13 to form a second power circuit with the storage capacitor 13 and the rectifier unit 10; wherein the voltage controlled transistor 14 limits current flowing in the storage capacitor 13 under a maximum current limit value; the second power circuit is connected in parallel with the first power circuit; in a preferred embodiment, the voltage controlled transistor 14 is a MOSFET or a BJT.

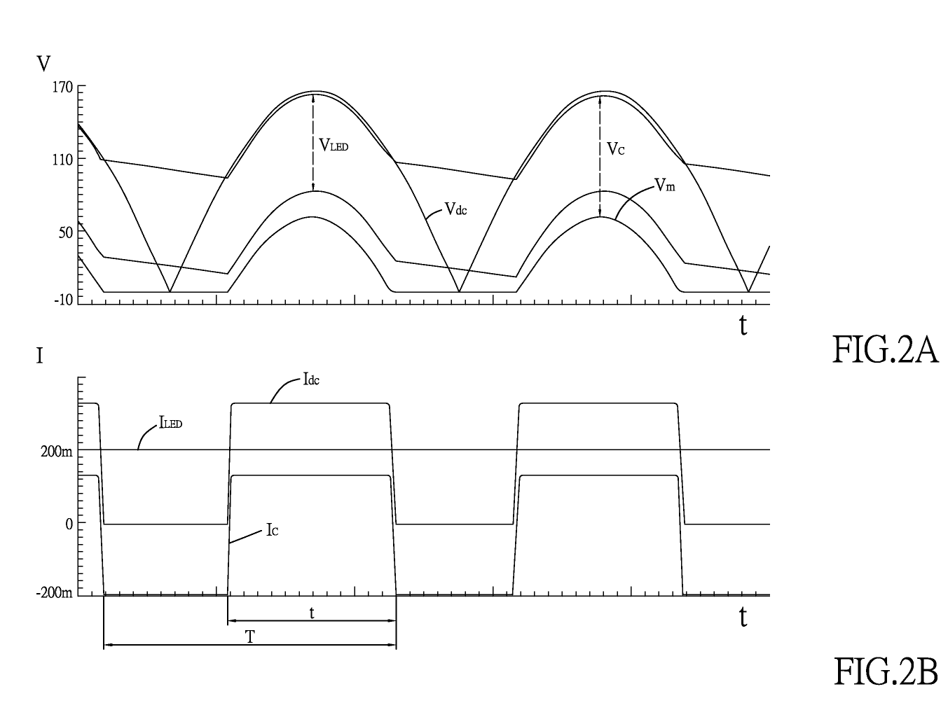

With reference to FIGS. 2A and 2B, when a voltage V_{dc} of the pulsating DC power outputted by the rectifier unit 10 is higher than a sum of a voltage V_{C} of the storage capacitor 13 and a voltage V_{M} of the voltage controlled transistor 14, current I_{dc} of the pulsating DC power supplies power to the LED unit 11 and charges the storage capacitor 13; wherein current I_{C} flows in the storage capacitor 13 is limited and under a maximum current limit value. When the voltage V_{dc} of the pulsating DC power outputted by the rectifier unit 10 is lower than the sum of the voltage V_{C} of the storage capacitor 13 and the voltage V_{M} of the voltage controlled transistor 14, the current I_{C} of the storage capacitor 13 supplies power to the LED unit 11.

The LED driver circuit limits the current I_{C} flowing in the storage capacitor 13 under a maximum current limit value such that the current I_{C} flowing in the storage capacitor 13 is not instantaneously raised to an extremely high value, thereby preventing the current I_{C} of the storage capacitor 13 from forming a glitch waveform having high amplitude, that is, a harmonic distortion between the voltage V_{dc} and the current I_{dc} of the pulsating DC power is decreased.

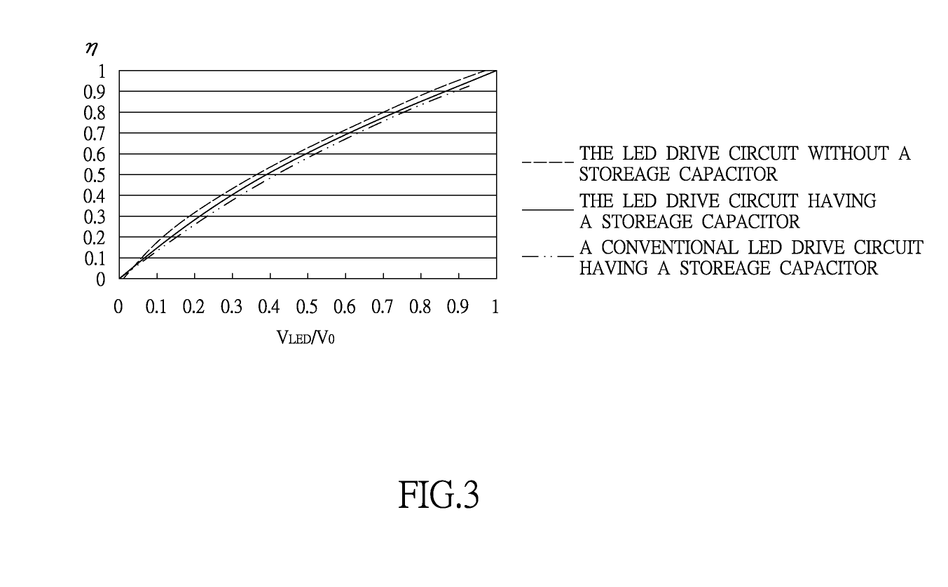

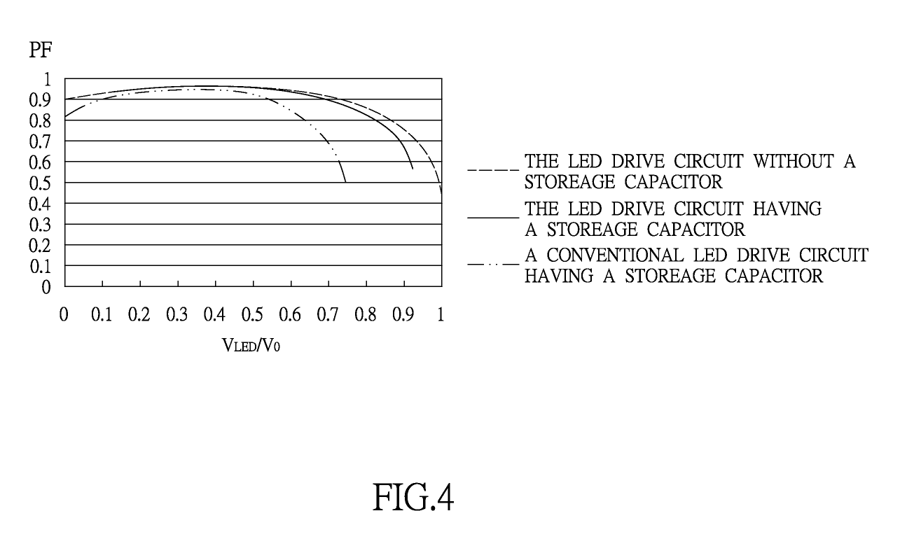

With reference to FIGS. 3 and 4, the power factor (PF) of the LED driver circuit in accordance with the present invention is plotted as a function of the ratio of the LED voltage drop (V_{LED}) and the amplitude of the input AC voltage (V₀). The efficiency (η) and the power factor (PF) of the LED driver circuit in accordance with the present invention are both higher than those of a conventional LED driver circuit.

With reference to FIGS. 1 and 2B, the voltage controlled transistor 14 increases a charge time of the storage capacitor 13 to decrease the THD (total harmonic distortion), and further increases the power factor (PF). Hence, how to control and set the maximum current limit value is important. When the maximum current limit value is infinity (that is, the voltage controlled transistor 14 is in conduction state), waveforms of the voltage V_{dc} and the current I_{dc} of the pulsating DC power outputted by the rectifier unit 10 are similar to those of the conventional LED driver circuit. When the maximum current limit value is 0 (that is, the voltage controlled transistor 14 is in off state), the waveforms of the voltage V_{dc} and the current I_{dc} of the pulsating DC power outputted by the rectifier unit 10 are similar to those of the conventional LED driver circuit without the storage capacitor 13. Therefore, the following description will explain and elaborate a control method of the voltage controlled transistor 14.

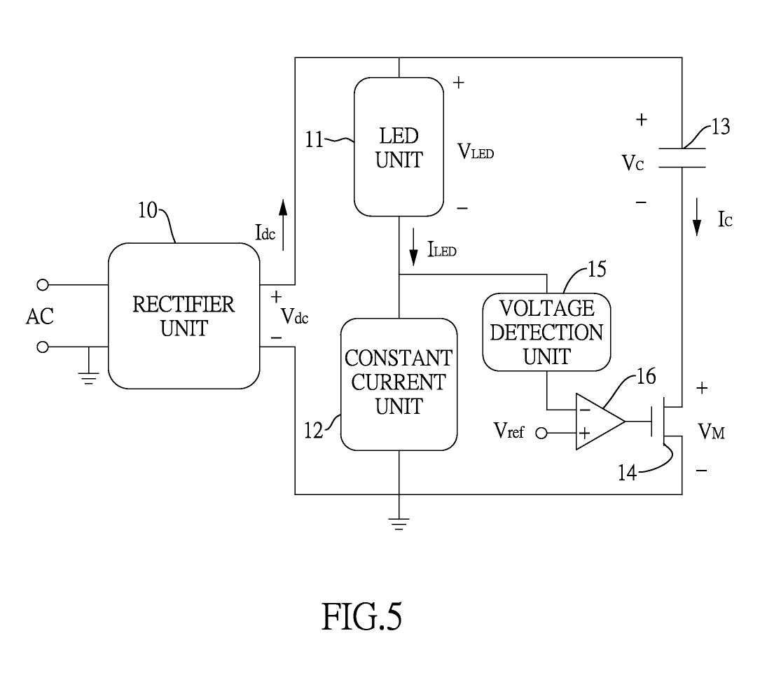

In another preferred embodiment as shown in FIG. 5, the voltage controlled transistor 14 comprises a control terminal, and the LED driver circuit in accordance with the present invention further comprises:
a voltage detection unit 15 having an input terminal and an output terminal; wherein the input terminal is connected to a series node between the LED unit 11 and the constant current unit 12; the voltage detection unit 16 is used for detecting an average value of minimum voltage of the constant current unit 12; and
a loop controller 16 having a first input terminal, a second input terminal and an output terminal; wherein the first input terminal of the loop controller 16 is electrically connected to the output terminal of the voltage detection unit 15, the second input terminal is electrically connected to a reference voltage V_{ref}, the output terminal of the loop controller 16 is electrically connected to the control terminal of the voltage controlled transistor 14; wherein the loop controller 16 controls the maximum current limit value of the voltage controlled transistor 14 based on a voltage difference between the first input terminal and the second input terminal; in a preferred embodiment, the loop controller 16 is an operational amplifier.

Based on principle of charge conservation of a capacitor, in a steady-state system, charges flowing into the capacitor equal charges flowing out of the capacitor. Hence, as observed from FIG. 2B, the charges flowing into the storage capacitor 13 (obtained by multiplying the charge current I_{C(t)} flowing into the storage capacitor 13 by the charge time t) must equal the charges flowing out of the storage capacitor 13 (obtained by multiplying the discharge current I_{C(T-t)} flowing into the storage capacitor 13 by the discharge time (T−t) to eliminate the stroboscopic effect. As observed from the diagram of the LED driver circuit of the present invention, when the charges flowing out of the storage capacitor 13 are more than the charges flowing into the storage capacitor 13, the current I_{C} of the storage capacitor 13 becomes 0A, and then the voltage of the constant current unit 12 also becomes 0V. In order to avoid the above-mentioned situation, the second embodiment of the LED driver circuit in accordance with the present invention further includes a voltage detection unit 15 connected to the constant current unit 12 to detect a minimum voltage of the constant current unit 12, and then adjusts the maximum current limit value of the voltage controlled transistor 14 by the loop controller 16.

When the voltage detection unit 15 detects that an average value of the minimum voltage is lower than the reference voltage V_{ref}, the loop controller 16 increases the maximum current limit value of the voltage controlled transistor 14 to increase the charge current I_{C(t)}, and further increases charges flowing into the storage capacitor 13 to eliminate the stroboscopic effect. When the voltage detection unit 15 detects that an average value of the minimum voltage is higher than the reference voltage V_{ref}, the loop controller 16 decreases the maximum current limit value of the voltage controlled transistor 14 to decrease the charge current I_{C(t)}, and further increases the charge time of the storage capacitor 13 to decrease the harmonic distortion, thereby further increasing the power factor.

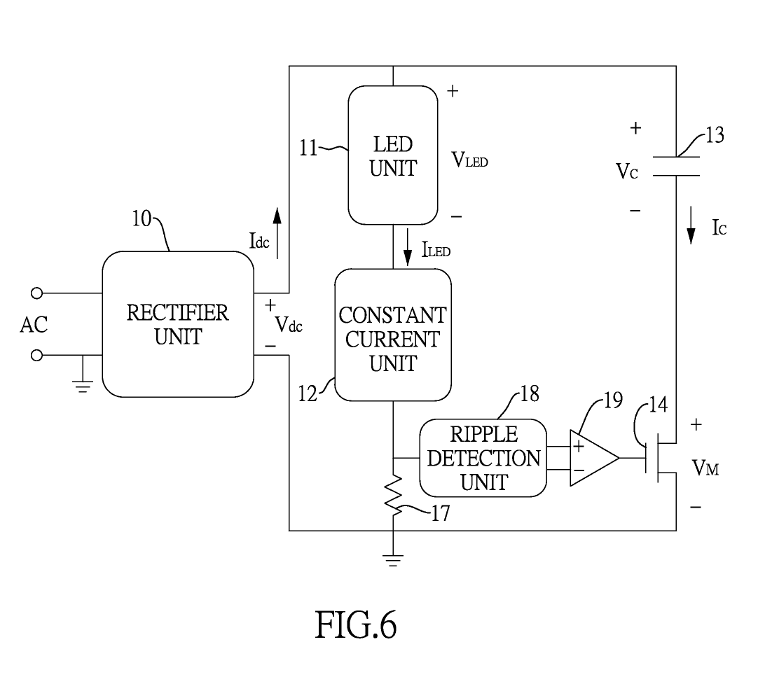

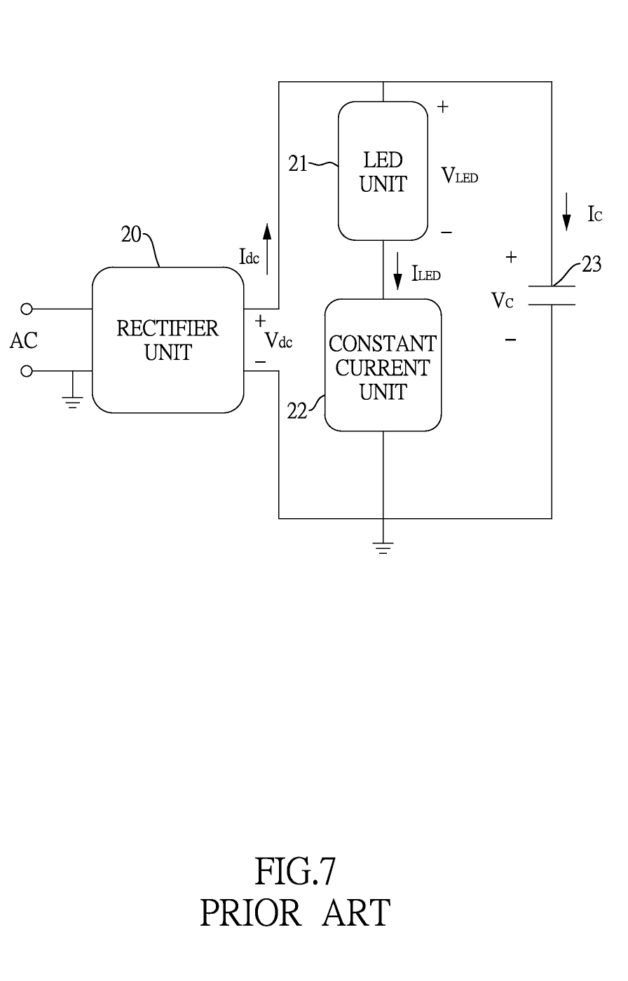

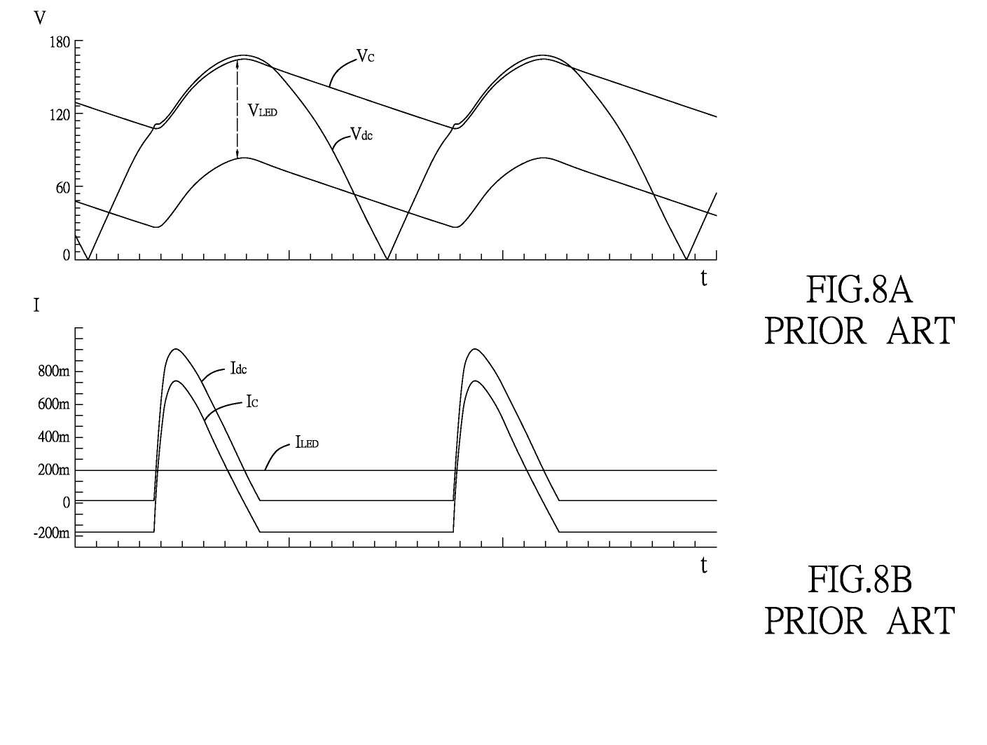

In addition, with reference to FIG. 6, besides detecting the voltage of the constant current unit 12 by the voltage detection unit 15 to find whether the current I_{C} is 0A when the storage capacitor 13 discharges, the current I_{C} can be directly detected by a current detection resistor 17. In another preferred embodiment, the LED circuit further comprises:
a current detection resistor 17 connected in series with the constant current unit 12 to detect current flow through the first power circuit;
a ripple detection unit 18 connected to a series node between the constant current unit 12 and the current detection resistor 17 to detect a ripple factor of the current flowing through the first power circuit by the current detection resistor 17; and
a feedback controller 19 having an input terminal, an output terminal and a built-in ripple standard; wherein the input terminal is connected to the ripple detection unit 18, the output terminal is connected to the control terminal of the voltage controlled transistor 14; wherein the feedback controller 19 controls the maximum current limit value of the voltage controlled transistor 14 based on the ripple factor and the built-in ripple standard; in a preferred embodiment, the feedback controller 19 is an operational amplifier.

The ripple factor increases when the current flowing through the first power circuit decreases. Therefore, when the ripple factor is higher than the ripple standard, the feedback controller 19 instantly increases the maximum current limit value of the voltage controlled transistor 14 to increase the charge current I_{C(t)}, so as to prevent the current I_{C} from approximating 0A and further eliminate the stroboscopic effect.

In conclusion, the LED driver circuit in accordance with the present invention can limit current flowing through the voltage controlled transistor 14, thereby increasing the power factor (PF) and still avoiding the stroboscopic effect.

What is claimed is:

1. A flicker-free linear LED driver circuit with high power factor comprising:
a rectifier unit connected to an AC power and converting the AC power into a pulsating DC power;
an LED unit connected to the rectifier unit and having multiple LED sources;
a constant current unit connected in series with the LED unit to form a first power circuit with the LED unit and the rectifier unit; wherein current flowing in the LED unit is fixed to a constant value by the constant current unit;
a storage capacitor connected to the rectifier unit; and
a voltage controlled transistor connected in series with the storage capacitor to form a second power circuit with the storage capacitor and the rectifier unit; wherein the voltage controlled transistor limits current flowing through the storage capacitor under a maximum current limit value.

2. The LED driver circuit as claimed in claim 1, wherein the voltage controlled transistor comprises a control terminal;
the LED driver circuit further comprises:
a voltage detection unit having an input terminal and an output terminal; wherein the input terminal is connected to a series node between the LED unit and the constant current unit; the voltage detection unit is used for detecting an average value of minimum voltage of the constant current unit; and
a loop controller having a first input terminal, a second input terminal and an output terminal; wherein the first input terminal is electrically connected to the output terminal of the voltage detection unit, the second input terminal is electrically connected to a reference voltage, and the output terminal of the loop controller is electrically connected to the control terminal of the voltage controlled transistor; wherein the loop controller controls the maximum current limit value of the voltage controlled transistor based on a voltage difference between the first input terminal and the second input terminal.

3. The LED driver circuit as claimed in claim 1, wherein the voltage controlled transistor comprises a control terminal;
the LED driver circuit further comprises:
a current detection resistor connected in series with the constant current unit to detect current flowing through the first power circuit;
a ripple detection unit connected to a series node between the constant current unit and the current detection resistor to detect a ripple factor of the current flowing through the first power circuit by the current detection resistor; and
a feedback controller having an input terminal, an output terminal and a built-in ripple standard; wherein the input terminal of the feedback controller is connected to the ripple detection unit, the output terminal of the feedback controller is connected to the control terminal of the voltage controlled transistor; wherein the feedback controller controls the maximum current limit value of the voltage controlled transistor based on the ripple factor and the built-in ripple standard.

4. The LED driver circuit as claimed in claim 2, wherein the loop controller is an operational amplifier.

5. The LED driver circuit as claimed in claim 3, wherein the feedback controller is an operational amplifier.

6. The LED driver circuit as claimed in claim 1, wherein the rectifier unit is a full-wave rectifier.

7. The LED driver circuit as claimed in claim 5, wherein the rectifier unit is a full-wave rectifier.

8. The LED driver circuit as claimed in claim 1, wherein the voltage controlled transistor is a MOSFET.

9. The LED driver circuit as claimed in claim 7, wherein the voltage controlled transistor is a MOSFET.

10. The LED driver circuit as claimed in claim 1, wherein the voltage controlled transistor is a BJT.

11. The LED driver circuit as claimed in claim 7, wherein the voltage controlled transistor is a BJT.
